(19) United States
(12) Patent Application Publication
(10) Pub. No.: US 2025/0328377 A1
(43) Pub. Date: Oct. 23, 2025

(54) SYSTEMS AND METHODS FOR SCHEDULING WORKLOADS

(71) Applicant: Advanced Micro Devices, Inc., Santa Clara, CA (US)

(72) Inventors: Johnathan Alsop, Bellevue, WA (US); Suchita Pati, Fort Collins, CO (US); Shaizeen Aga, Santa Clara, CA (US); Sergey Blagodurov, Bellevue, WA (US)

(73) Assignee: Advanced Micro Devices, Inc., Santa Clara, CA (US)

(21) Appl. No.: 18/088,884

(22) Filed: Dec. 27, 2022

(51) Int. Cl. G06F 9/48; G06F 9/54; G06F 11/30

(52) U.S. Cl. CPC G06F 9/4881; G06F 9/544; G06F 11/3051

(57) ABSTRACT

The disclosed computing device can include collection circuitry configured to collect current resource utilization per shared resource location. The computing device can also include formulation circuitry configured, using expected resource utilization information of a new workload and the current resource utilization, to provide a scheduler with one or more expected utilization metrics. Various other methods, systems, and computer-readable media are also disclosed.

### BACKGROUND

A data center is a building, a dedicated space within a building, or a group of buildings used to house computer systems and associated components, such as telecommunications and/or storage systems. In computing, scheduling is the action of assigning resources to perform tasks. The resources can be processors, network links or expansion cards. The tasks can be threads, processes or data flows. The scheduling activity is carried out by a process called a scheduler. Schedulers are often designed so as to keep all computer resources busy (as in load balancing), allow multiple users to share system resources effectively, and/or to achieve a target quality-of-service.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for scheduling workloads.

FIG. 2 is a block diagram of an additional example system for scheduling workloads.

FIG. 3 is a flow diagram of an example method for scheduling workloads.

FIG. 4 is a block diagram illustrating an example system having a utilization manager and a scheduler for scheduling data center workloads for data center resources at different hierarchical levels.

FIG. 5 is a block diagram illustrating a utilization manager for scheduling workloads.

FIG. 6 is a set of flow diagrams illustrating procedures implemented by a utilization manager for scheduling workloads.

FIG. 7 is a flow diagram illustrating provision of a total expected utilization by a utilization manager for scheduling workloads.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to systems and methods for scheduling workloads. Coscheduling multiple parallel kernels from the same application or from independent applications is often desirable in HPC and data center settings to maximize the utilization of available compute resources. However, coscheduling workloads can result in performance degradation, sometimes even leading to slower execution than if either were run serially. This is particularly true when the coscheduled workloads are bottlenecked by the same shared system resources. Being able to identify and avoid these situations will ensure efficient utilization of compute resources under coscheduling. Improvements can be achieved via intelligent kernel implementation selection (e.g., in cases where there are multiple possible kernels that can be run) and via intelligent scheduling of selected kernels. However, identifying the best strategy requires information and insights that are not currently available to most schedulers.

The need to coschedule multiple workloads rises with increase in computing power, and thus it can be advantageous to avoid allowing shared resources to go unutilized. The disclosed systems and methods provide techniques for quickly determining which workloads will not interfere with one another and scheduling them together. This capability is realized by measuring the proportion of shared resources utilized by each workload and providing this information to scheduling logic to coschedule workloads that are bottlenecked by different resources.

In one example, a computing device includes collection circuitry configured to collect current resource utilization per shared resource location, and formulation circuitry configured, using expected resource utilization information of a new workload and the current resource utilization, to provide a scheduler with one or more expected utilization metrics.

Another example can be the previously described computing device, further including monitoring circuitry configured to measure resource utilization of currently running workloads at different shared resource locations and provide the measured resource utilization to the collection circuitry.

Another example can be the computing device of any of the previously described computing devices, further including a scheduler configured to schedule workloads that utilize shared resources at one or more of the different shared resource locations based at least in part on the one or more expected utilization metrics.

Another example can be the computing device of any of the previously described computing devices, wherein the different shared resource locations correspond to multiple hierarchical locations at different hierarchical sharing levels, the monitoring circuitry is configured to measure the current resource utilization of the currently running workloads at different hierarchical granularities, and the scheduler is configured to perform multi-level scheduling while avoiding duplication of resources across different scheduling levels.

Another example can be the computing device of any of the previously described computing devices, wherein the one or more expected utilization metrics correspond to a total expected utilization matrix that represents utilization of a limiting resource at a location when a current utilization is added to the expected resource utilization information of the new workload for each workload and location pair supplied by the scheduler.

Another example can be the computing device of any of the previously described computing devices, wherein the formulation circuitry is configured to maintain the current resource utilization per location in a per-location hardware utilization matrix that represents the current resource utilization at each location that is at least one of being monitored or indicated by the scheduler as under consideration for scheduling.

Another example can be the computing device of any of the previously described computing devices, wherein the formulation circuitry is configured to maintain the expected resource utilization information of the new workload in a per-workload isolated utilization matrix that represents the expected resource utilization for each workload indicated by the scheduler as under consideration for scheduling.

Another example can be the computing device of any of the previously described computing devices, wherein the formulation circuitry is configured to formulate the total expected utilization matrix at least in part by extracting a locations dimension by resources dimension matrix of utilization of values from the per-location hardware utilization matrix, extracting a workloads dimension by resources dimension matrix of utilization values from the per-workload isolated utilization matrix, combining the locations dimension by resources dimension matrix of utilization of values and the workloads dimension by resources dimension matrix of utilization values by reducing the resources dimension in a manner that produces a locations dimension by workloads dimension total expected utilization matrix.

Another example can be the computing device of any of the previously described computing devices, wherein the formulation circuitry is further configured to formulate the total expected utilization matrix at least in part by scaling, for a specified scheduling granularity, utilization values extracted from the per-workload isolated utilization matrix and dividing the scaled utilization values by a peak value for a specified resource at a specified location.

Another example can be the computing device of any of the previously described computing devices, wherein the formulation circuitry is further configured to evaluate predicted interference based on post-monitoring scheduling and respond to the evaluation for non-amenable workloads and/or systems by disabling provision of the one or more expected utilization metrics to the scheduler and/or providing the scheduler with one or more expected utilization metrics corresponding to null values.

Another example can be the computing device of any of the previously described computing devices, wherein the formulation circuitry is further configured to provide a predicted execution time to the scheduler based on resource usage and availability.

In one example, a system can include at least one physical processor and a physical memory comprising computer-executable instructions that, when executed by the physical processor, cause the physical processor to collect current resource utilization per shared resource location, and provide, using expected resource utilization information of a new workload and the current resource utilization, a scheduler with one or more expected utilization metrics.

Another example can be the system of the previously described example system, wherein the instructions further cause the physical processor to measure resource utilization of currently running workloads at different shared resource locations.

Another example can be the system of any of the previously described example systems, wherein the instructions further cause the physical processor to schedule workloads that utilize shared resources at one or more of the different shared resource locations based at least in part on the one or more expected utilization metrics.

Another example can be the system of any of the previously described example systems, wherein the different shared resource locations correspond to multiple hierarchical locations at different hierarchical sharing levels, and the instructions further cause the physical processor to measure the current resource utilization of the currently running workloads at different hierarchical granularities, and perform multi-level scheduling while avoiding duplication of resources across different scheduling levels.

Another example can be the system of any of the previously described example systems, wherein the one or more expected utilization metrics correspond to a total expected utilization matrix that represents utilization of a limiting resource at a location when a current utilization is added to the expected resource utilization information of the new workload for each workload and location pair.

Another example can be the system of any of the previously described example systems, wherein the instructions further cause the physical processor to maintain the current resource utilization per location in a per-location hardware utilization matrix that represents the current resource utilization at each location that is at least one of being monitored or under consideration for scheduling.

Another example can be the system of any of the previously described example systems, wherein the instructions further cause the physical processor to maintain the expected resource utilization information of the new workload in a per-workload isolated utilization matrix that represents the expected resource utilization for each workload under consideration for scheduling.

Another example can be the system of any of the previously described example systems, wherein the instructions cause the physical processor to formulate the total expected utilization matrix at least in part by extracting a locations dimension by resources dimension matrix of utilization of values from the per-location hardware utilization matrix, extracting a workloads dimension by resources dimension matrix of utilization values from the per-workload isolated utilization matrix, and combining the locations dimension by resources dimension matrix of utilization of values and the workloads dimension by resources dimension matrix of utilization values by reducing the resources dimension in a manner that produces a locations dimension by workloads dimension total expected utilization matrix.

Another example can be the system of any of the previously described example systems, wherein the instructions cause the physical processor to formulate the total expected utilization matrix at least in part by scaling, for a specified scheduling granularity, utilization values extracted from the per-workload isolated utilization matrix and dividing the scaled utilization values by a peak value for a specified resource at a specified location.

In one example, a computer-implemented method can include collecting, by at least one processor, current resource utilization per shared resource location, and providing, by the at least one processor and using expected resource utilization information of a new workload and the current resource utilization, a scheduler with one or more expected utilization metrics.

Another example can be the previously described example method, further including measuring, by the at least one processor, resource utilization of currently running workloads at different shared resource locations, and scheduling, by the at least one processor, workloads that utilize shared resources at one or more of the different shared resource locations based at least in part on the one or more expected utilization metrics.

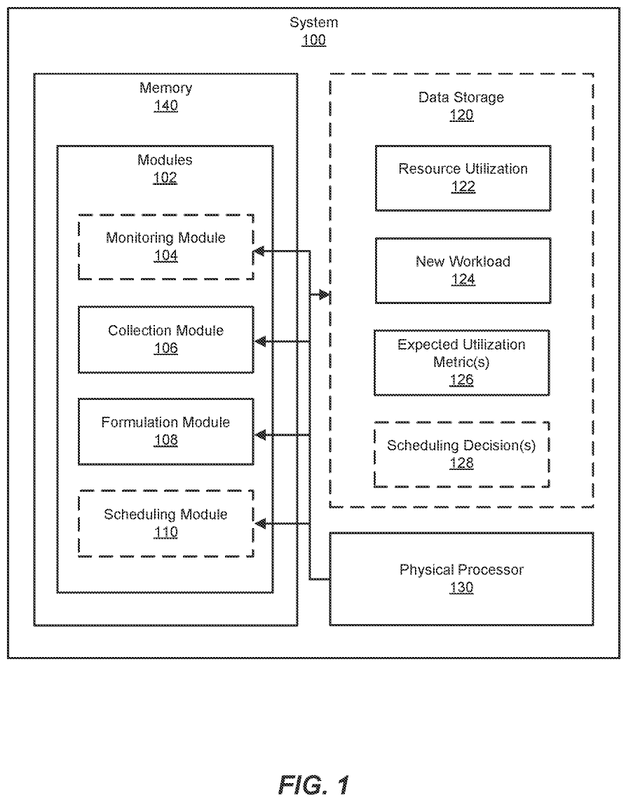

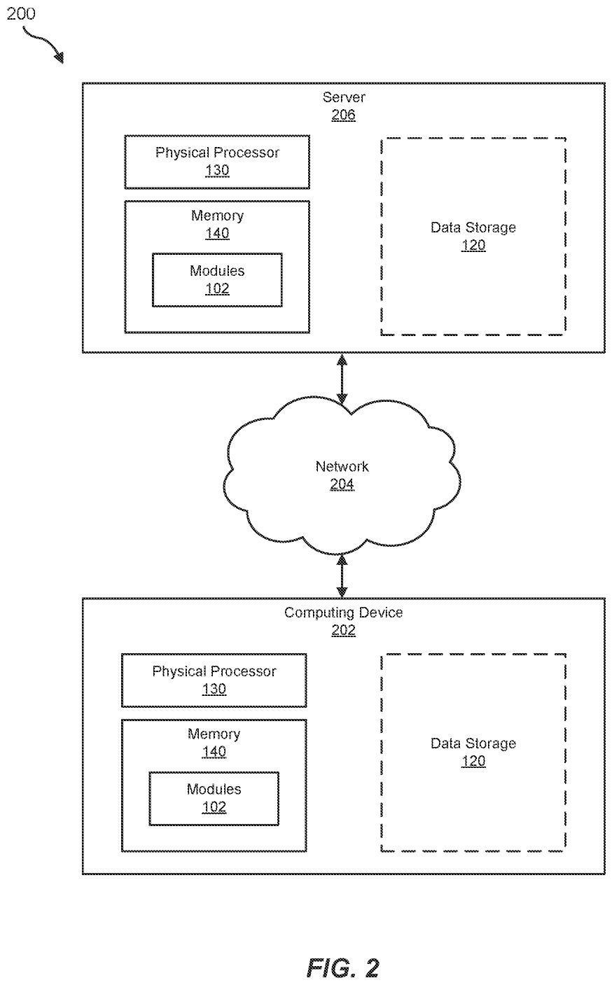

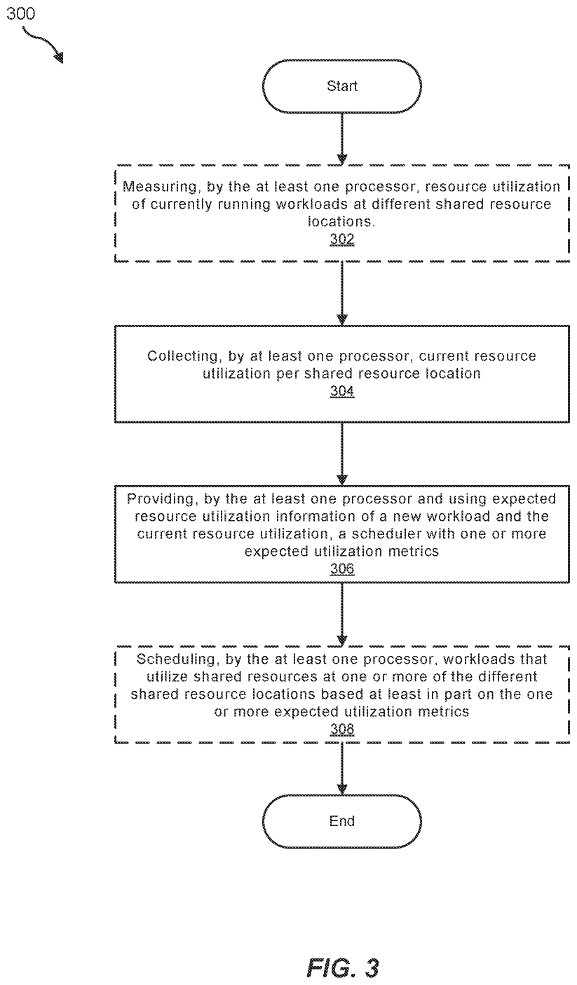

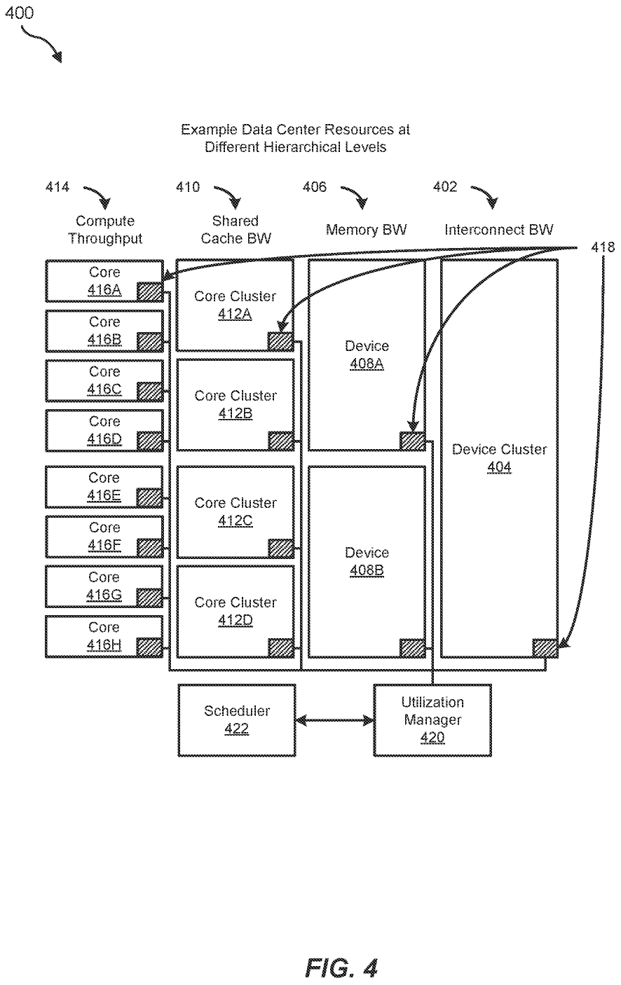

The following will provide, with reference to FIGS. 1-2, detailed descriptions of example systems for scheduling workloads. Detailed descriptions of corresponding computer-implemented methods will also be provided in connection with FIG. 3. In addition, detailed descriptions of example data center resources, systems for scheduling data center workloads, utilization managers, and procedures implemented by utilization managers will be provided in connection with FIGS. 4-7.

FIG. 1 is a block diagram of an example system 100 for scheduling workloads. As illustrated in this figure, example system 100 can include one or more modules 102 for performing one or more tasks. As will be explained in greater detail below, modules 102 can include monitoring module 104, a collection module 106, a formulation module 108, and a scheduling module 110. Although illustrated as separate elements, one or more of modules 102 in FIG. 1 can represent portions of a single module or application.

In certain implementations, one or more of modules 102 in FIG. 1 can represent one or more software applications or programs that, when executed by a computing device, can cause the computing device to perform one or more tasks. For example, and as will be described in greater detail below, one or more of modules 102 can represent modules stored and configured to run on one or more computing devices, such as the devices illustrated in FIG. 2 (e.g., computing device 202 and/or server 206). One or more of modules 102 in FIG. 1 can also represent all or portions of one or more special-purpose computers configured to perform one or more tasks. Alternatively or additionally, modules 102 can execute based on local private firmware and/or hardwired hardware logic.

As illustrated in FIG. 1, example system 100 can also include one or more memory devices, such as memory 140. Memory 140 generally represents any type or form of volatile or non-volatile storage device or medium capable of storing data and/or computer-readable instructions. In one example, memory 140 can store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 1, example system 100 can also include one or more physical processors, such as physical processor 130. Physical processor 130 generally represents any type or form of hardware-implemented processing unit capable of interpreting and/or executing computer-readable instructions. In one example, physical processor 130 can access and/or modify one or more of modules 102 stored in memory 140. Additionally or alternatively, physical processor 130 can execute one or more of modules 102 to facilitate scheduling workloads. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As illustrated in FIG. 1, example system 100 can also include one or more instances of stored data, such as data storage 120. Data storage 120 generally represents any type or form of stored data. In one example, data storage 120 includes databases, spreadsheets, tables, lists, matrices, trees, or any other type of data structure. Examples of data storage 120 include, without limitation, resource utilization 122, new workload 124, expected utilization metric(s) 126, and scheduling decision(s) 128.

Example system 100 in FIG. 1 can be implemented in a variety of ways. For example, all or a portion of example system 100 can represent portions of example system 200 in FIG. 2. As shown in FIG. 2, system 200 can include a computing device 202 in communication with a server 206 via a network 204. In one example, all or a portion of the functionality of modules 102 can be performed by computing device 202, server 206, and/or any other suitable computing system. As will be described in greater detail below, one or more of modules 102 from FIG. 1 can, when executed by at least one processor of computing device 202 and/or server 206, enable computing device 202 and/or server 206 to schedule workloads.

Computing device 202 generally represents any type or form of computing device capable of reading computer-executable instructions. For example, computing device is any computer capable of receiving, processing, and storing data. Additional examples of computing device 202 include, without limitation, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device.

Server 206 generally represents any type or form of computing device that is capable of receiving, processing, and storing data. Additional examples of server 206 include, without limitation, storage servers, database servers, application servers, and/or web servers configured to run certain software applications and/or provide various storage, database, and/or web services. Although illustrated as a single entity in FIG. 2, server 206 can include and/or represent a plurality of servers that work and/or operate in conjunction with one another.

Network 204 generally represents any medium or architecture capable of facilitating communication or data transfer. In one example, network 204 can facilitate communication between computing device 202 and server 206. In this example, network 204 can facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

Many other devices or subsystems can be connected to system 100 in FIG. 1 and/or system 200 in FIG. 2. Conversely, all of the components and devices illustrated in FIGS. 1 and 2 need not be present to practice the implementations described and/or illustrated herein. The devices and subsystems referenced above can also be interconnected in different ways from that shown in FIG. 2. Systems 100 and 200 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

FIG. 3 is a flow diagram of an example computer-implemented method 300 for scheduling workloads. The steps shown in FIG. 3 can be performed by any suitable computer-executable code and/or computing system, including system 100 in FIG. 1, system 200 in FIG. 2, and/or variations or combinations of one or more of the same. In one example, each of the steps shown in FIG. 3 can represent an algorithm whose structure includes and/or is represented by multiple sub-steps, examples of which will be provided in greater detail below.

As illustrated in FIG. 3, at step 302 one or more of the systems described herein can measure resource utilization. For example, monitoring module 104 can, as part of computing device 202 in FIG. 2, measure, by the at least one processor, resource utilization of currently running workloads at different shared resource locations.

The term “computer-implemented,” as used herein, generally refers to hardware, software, or any combination thereof. For example, and without limitation, computer-implemented can refer to specific hardware logic configured to schedule workloads. Alternatively, computer-implemented can refer to software configured to schedule workloads. Alternatively, computer-implemented can refer to a general-purpose processor in combination with software that configures the general-purpose processor to schedule workloads. Alternatively, computer-implemented can refer to a combination of a general-purpose processor, software, and specific hardware logic configured to schedule workloads.

The terms “processor” and “physical processor,” as used herein, generally refer to any circuitry capable of scheduling workloads. For example, and without limitation, processor and physical processor can refer to specific hardware logic configured to schedule workloads, a combination of a general-purpose processor that enacts machine-readable instructions, or combinations thereof.

The term “resource,” as used herein can generally refer to any physical or virtual component of limited availability within a computer system. For example, and without limitation, resource can refer to capacity of a processor, memory, or communication medium. Additional nonlimiting examples include processors, CPU (central processing unit) clock cycles, storage I/O (input/output), etc.

The term “workload,” as used herein, can generally refer to any program or application that runs on any computer. For example, and without limitation, workload can refer to the amount of work (or load) that software imposes on the underlying computing resources. Broadly stated, an application's workload is related to the amount of time and computing resources required to perform a specific task or produce an output from inputs provided. A light workload accomplishes its intended tasks or performance goals using relatively little computing resources. A heavy workload demands significant amounts of computing resources.

The term “location,” as used herein, can generally refer to any physical or logical distinction of a resource with respect to other resources. For example, and without limitation, location can refer to a data center building, a dedicated space within a building, or a group of buildings used to house computer systems and associated components, such as telecommunications and/or storage systems. Other nonlimiting examples can include a hierarchical level in a computing device or system.

The systems described herein can perform step 302 in a variety of ways. In some examples, monitoring module 104, as part of computing device 202 in FIG. 2, can measure resource utilization of multiple hierarchical locations at different hierarchical sharing levels. In some of these implementations, monitoring module 104, as part of computing device 202 in FIG. 2, can measure, by the at least one processor, the resource utilization of the currently running workloads at different hierarchical granularities.

At step 304 one or more of the systems described herein can collect resource utilization. For example, collection module 106 can, as part of computing device 202 in FIG. 2, collect, by at least one processor, current resource utilization per shared resource location.

The term “collect,” as used herein, can generally refer to obtaining and storing data. For example, and without limitation, collecting can include receiving, fetching, recording, detecting, storing, generating, updating, and/or maintaining data that is stored in a computer readable medium.

The systems described herein can perform step 304 in a variety of ways. In some examples, collection module 106, as part of computing device 202 in FIG. 2, can maintain, by the at least one processor, the current resource utilization per location in a per-location hardware utilization matrix that represents the current resource utilization at each location that is at least one of being monitored or under consideration for scheduling.

At step 306 one or more of the systems described herein can formulate one or more metrics. For example, formulation module 108 can, as part of computing device 202 in FIG. 2, provide, by the at least one processor and using expected resource utilization information of a new workload and the current resource utilization, a scheduler with one or more expected utilization metrics.

The term “metric,” as used herein, can generally refer to a set of numbers or statistics used for measuring something. For example, and without limitation, a metric can be a numerical or boolean value. Additional nonlimiting examples of metrics can include one or more utilization percentages arranged in a dimensional matrix. Example types of dimensional matrices include, without limitation, location and workload pairs (<location, workload>), a locations dimension (<#locations>) by resources dimension (<#resources>) (i.e., <#locations>x <#resources>) matrix, a workloads dimension <#workloads> by resources dimension (i.e., <#workloads>x< #resources>) matrix, and/or a locations dimension by workloads dimension (i.e., <#locations>x<#workloads>) matrix.

The systems described herein can perform step 306 in a variety of ways. In some examples, formulation module 108, as part of computing device 202 in FIG. 2, can formulate one or more expected utilization metrics that correspond to a total expected utilization matrix. This matrix can represent utilization of a limiting resource at a location when a current utilization is added to the expected resource utilization information of the new workload for each workload and location pair. This limiting resource can correspond to a resource at the location that is expected to be most highly utilized and therefore most likely to be limiting performance. This expected utilization matrix can serve as a proxy metric for expected performance degradation due to interference between currently running workloads at a location and a new workload for each workload and location pair. In some implementations, formulation module 108, as part of computing device 202 in FIG. 2, can maintain, by the at least one processor, the expected resource utilization information of the new workload in a per-workload isolated utilization matrix that represents the expected resource utilization for each workload under consideration for scheduling. In some implementations, formulation module 108, as part of computing device 202 in FIG. 2, can formulate the total expected utilization matrix by extracting, by the at least one processor, a locations dimension by resources dimension matrix of utilization of values from the per-location hardware utilization matrix, and extract, by the at least one processor, a workloads dimension by resources dimension matrix of utilization values from the per-workload isolated utilization matrix. In these implementations, formulation module 108, as part of computing device 202 in FIG. 2, can combine, by the at least one processor, the locations dimension by resources dimension matrix of utilization of values and the workloads dimension by resources dimension matrix of utilization values by reducing the resources dimension in a manner that produces a locations dimension by workloads dimension total expected utilization matrix. In some implementations, formulation module 108, as part of computing device 202 in FIG. 2, can evaluate predicted interference based on post-monitoring scheduling and respond to the evaluation for non-amenable workloads and/or systems by disabling provision of the one or more expected utilization metrics to the scheduler and/or providing the scheduler with one or more expected utilization metrics corresponding to null values. In some implementations, formulation module 108, as part of computing device 202 in FIG. 2, can provide a predicted execution time to the scheduler based on resource usage and availability.

At step 308 one or more of the systems described herein can schedule one or more workloads. For example, scheduling module 110 can, as part of computing device 202 in FIG. 2, schedule, by the at least one processor, workloads that utilize shared resources at one or more of the different shared resource locations based at least in part on the one or more expected utilization metrics.

The term “schedule,” as used herein, can generally refer to the action of assigning resources to perform tasks. For example, and without limitation, types of scheduling can include assigning processors, network links, and/or expansion cards to carry out tasks that can correspond to threads, processes, and/or data flows. The scheduling activity can be carried out by a process called a scheduler.

The systems described herein can perform step 308 in a variety of ways. In some examples, scheduling module 110, as part of computing device 202 in FIG. 2, can perform, by the at least one processor, multi-level scheduling while avoiding duplication of resources (e.g., common resources, logic, infrastructure, etc.) across different scheduling levels.

FIG. 4 illustrates an example system 400 having a utilization manager 420 and a scheduler 422 for scheduling workloads for data center resources at different hierarchical levels. In example system 400, the data center resources are arranged in hierarchical levels corresponding to an interconnect bandwidth level 402, a memory bandwidth level 406, a shared cache bandwidth level 410, and a compute throughput level 414. Interconnect bandwidth level 402 includes device cluster 404. Memory bandwidth level 406 includes devices 408A and 408B. Shared cache bandwidth level 410 includes core clusters 412A-412D, and compute throughput level 414 includes cores 416A-416H. Each of these locations has monitoring circuitry 418 configured to measure local resource utilization and provide this information to utilization manager 420 over any suitable communication medium. In turn, utilization manager communicates with scheduler 422 to carry out the operations described herein.

Example system 400 provides a mechanism to improve workload scheduling decisions by providing a measure of resource interference for a range of possible workload scheduling options. For example, monitoring circuitry 418 near shared resources can measure the current resource utilization of currently running workloads at different locations and hierarchical granularities in the system. Additionally, utilization manager 420 gathers current hardware data from monitoring circuitry 418 (e.g., in a per-location hardware utilization matrix) and, using the expected resource utilization information of a new workload (e.g., in a per-workload isolated utilization matrix), provides the scheduler with the expected limiting/interfering resource for scheduling a new workload at each location (e.g., in a total expected utilization matrix). The limiting/interfering resource refers to the resource that is expected to be most highly utilized and therefore most likely to be limiting performance.

The disclosed techniques for scheduling data center workloads can be applied at multiple scheduling granularities (e.g., kernel or workgroup scheduling within a GPU, thread scheduling in a server, or launching a collection of parallel tasks across multiple distributed devices). The scheduler 422 can use the utilization and interference information provided by the utilization manager 420, along with size/capacity limitations, data locality considerations, and priority/criticality/QoS requirements, to improve resource utilization and reduce interference when choosing which kernel to schedule to which location in a system.

While this roofline-based utilization model does not work for all workloads (e.g., due to non-linear interference effects, or workloads with input-dependent behavior, irregularity, or rapid variation in behavior over time), many of the most important workloads are regular (e.g., general matrix multiplies (GEMMs)) or exhibit predictable high-level behavior (e.g., graph operations on power-law graphs). When the disclosed techniques do not provide benefit, this lack of benefit can quickly be discerned, and the methodology can be disabled. Also, although this disclosure focuses on a centralized controller design, in a distributed system, utilization managers can be placed at each node and interface with a centralized or distributed scheduler.

The disclosed techniques can consider the relevant resource utilization information, how this information might be monitored, and at what granularity it is likely to be shared for an example system. Existing profiling and debug support already provides some visibility into resource utilization. Relevant system metrics can include, without limitation, compute throughput, register or scratchpad bandwidth, cache bandwidth/capacity, memory bandwidth, page table and/or translation lookaside buffer (TLB) bandwidth/capacity, network bandwidth, and performance monitors. Examples of types of resource monitors are provided below.

For compute throughput, instructions per cycle (IPC) counters, particularly if broken down by type, can be used to estimate compute utilization. In conventional GPUs, this resource is shared at a core/workgroup granularity.

For register or scratchpad bandwidth, near-register and near-scratchpad counters can keep track of how many accesses occur within a specified time window. Again, this measurement is shared at core/workgroup granularity.

For cache bandwidth/capacity, near-cache counters can be used to determine how many tag lookups occur, and how many new lines are allocated within a specified time window. This measurement can also be tracked at kernel granularity for more precise utilization data. Sharing granularity corresponds to cache level.

For memory bandwidth, near-memory counters can be used to determine how many accesses occur within a specified time window. This measurement can also be tracked at kernel granularity for more precise utilization data. Sharing granularity is generally at the device level unless multiple devices share a memory interface, in which case it is broader.

For page table and/or TLB bandwidth/capacity, TLB miss/allocation events can be logged and counted within a specified time window. Again, this measurement can be tracked at kernel granularity. Sharing granularity corresponds to TLB level.

For network bandwidth, the network bandwidth at various links can be tracked via counters within switches and routers. The sharing granularity and the precise way to combine counters can depend heavily on the network topology. However, link utilization can be grouped broadly based on sets of links that can form a bandwidth bottleneck, and the sharing granularity can correspond to any devices that send data across those links. Resource utilization values can be accessed via memory-mapped (or RDMA-like) accesses from the controller.

For performance monitors, some performance monitors (e.g., in addition to resource monitors) can be used for the purpose of monitoring system accuracy. These performance monitors can be per-kernel IPC monitors or near-scheduler systems for logging/tracking the rate of task completion for different workloads (i.e., execution time or workload completion rate).

When deciding which metrics to utilize for a target system, the resources that are most likely to become performance bottlenecks for the target system and the target application domain(s) can be prioritized. The disclosed systems and methods can use metrics to estimate which resources are likely to become performance bottlenecks by estimating what percentage is used by a set of workloads as a proportion of some finite peak. For bandwidth metrics, this peak is clearly defined for a given system. For capacity-related metrics (e.g., rate of cache line replacement, rate of TLB replacement events, etc.), a heuristic methodology can be used that, potentially based on offline profiling, assigns a rate threshold corresponding to an ideal rate for a device. Below this rate threshold, the resource can be considered underutilized, and performance can be expected to improve with more parallelism. Above this rate threshold, the resource can be considered overutilized and performance can be expected to improve with less parallelism. Utilization percentage can be the experienced rate divided by this ideal rate. Similarly, for cache conflicts, the performance counters can be programmed to be further nuanced to provide per-cacheline replacement rates, tracked for a subset of cache lines or sets. If the variance in replacement rates as well as their absolute values are high compared to ideal values (e.g., potentially estimated via offline profiling), then there can be a higher potential for cache conflicts when coscheduled.

FIG. 4 illustrates hierarchical sharing levels for an example system 400 and example metrics for each level. The disclosed techniques add utilization manager 420, which samples these metrics at a programmable frequency to keep track of the current resource utilization for multiple resources at multiple locations for storage in a per-location hardware utilization matrix. These metrics can also be used to estimate expected resource usage for different workloads. These metrics can be considered differently for different scheduling granularities. For example, when considering a fine-grain metric for coarse-grain scheduling (e.g., compute throughput for scheduling a kernel to a device), the current resource utilization at all cores in the target device can be added together and compared with the expected resource utilization of the full kernel. This comparison provides a full picture of the aggregate compute throughput used (and therefore the available slack) at that device.

When considering a coarse-grain metric for fine-grain scheduling (e.g., memory bandwidth for scheduling a workgroup to a core), the expected resource utilization of the fine-grain workload can be compared against the total current utilization of the coarse-grain resource. The coarse-grain utilization is not divided to match the scheduling granularity because that would prevent imbalanced sharing (e.g., some cores utilize very little memory bandwidth while others utilize significant memory bandwidth), which can be desirable.

Expected resource utilization for workloads to-be-scheduled (i.e., the per-workload isolated utilization matrix) can be used for comparison against existing resource utilization in order to inform scheduling decisions. This utilization information can be approximated in various ways, such as profiling in isolation, online profiling, and/or offline (i.e., static) analysis. For profiling in isolation, a target workload can be scheduled to an idle device and the utilization of each resource measured. To minimize approximation overhead and latency, a fine-grain version of the workload (e.g., a single representative workgroup) can be scheduled for this test. For online profiling, resource utilization can be measured during the normal course of execution, including measuring utilization before and after scheduling a workload to a location. Again, a fine-grained version of the target workload is sufficient. Additionally, it can be preferable to perform this test on a device with underutilized resources, as it is easier to estimate the added utilization contributed by the target workload when peak utilization is not quickly reached for any resource, although per-kernel utilization counters can assist with the estimate). For offline analysis, the disclosed techniques can statically estimate the resource usage of regular kernels for the purposes of a roofline analysis. This estimation can be accomplished by counting the number of compute operations performed and the number of memory accesses, using a heuristic to approximate cache hit rates at different levels, and then taking the aggregate demand for each resource and dividing that by the estimated time it would take to complete for whichever resource is limiting for an example device. Once calculated, the per-workload isolated utilization information can be stored in the local memory since it is likely to be reused during an application execution (e.g., repeating layers within a deep neural network (DNN) model, repeating iterations in DNN training, etc.). Frameworks can further log and store the data to disk for subsequent application invocation.

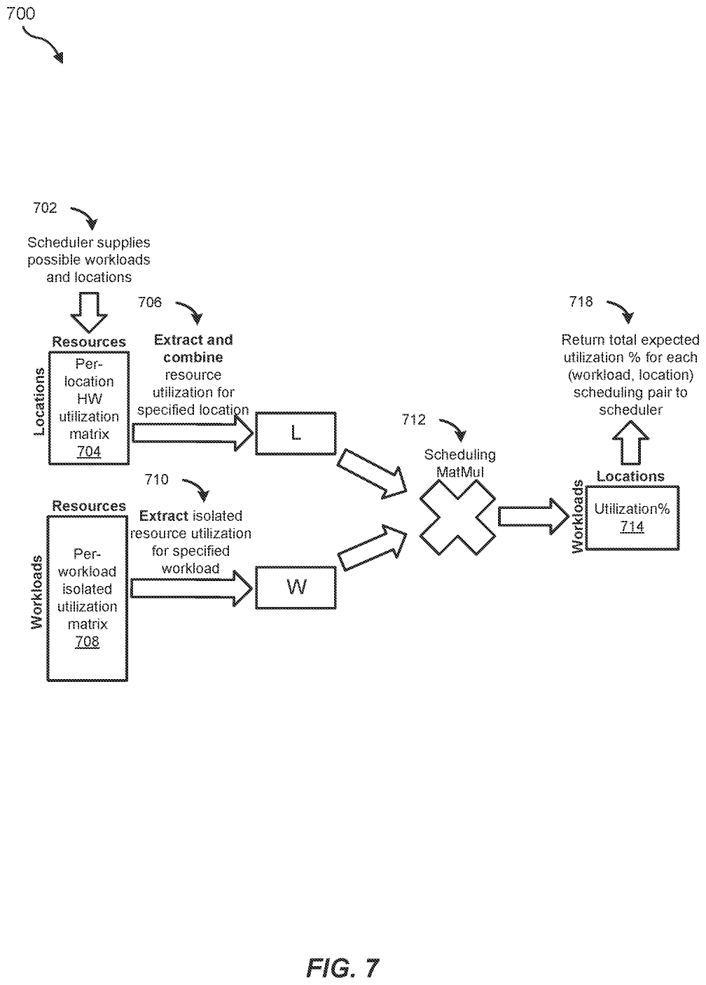

Similar to the per-location hardware utilization, the per-workload isolated utilization can also benefit from scaling for different scheduling granularities and scheduling locations (e.g., with different peaks). In some implementations, a simple model can be used for scaling expected resource demand, with utilization scaling linearly with added parallelism until the peak of any resource is reached. In an example, a utilization estimate for a fine-grain workload on one device can be scaled for use in scheduling a coarse grain version of that workload (e.g., potentially on another device). This scaling can be performed by multiplying all utilization factors by a parallelism multiplier (e.g., for workgroup->kernel scaling, this is the number of workgroups launched by the kernel), and then dividing all utilization factors by the smallest factor required to bring all utilization factors less than or equal to the peak available at the scheduling granularity for the target location. Since scaling is based on per-location parallelism and peak information, the scaling can be performed separately for each <location, workload>combination. In some implementations, the scaling can be performed within a MatMul procedure described later with reference to FIG. 7, as this procedure already loops over these dimensions.

Generally speaking, scaling the per-workload isolated utilization from coarse- to fine-grain can be avoided because utilization at lower levels of parallelism can be difficult to predict. A lower thread count is still able to utilize the same level of resource bandwidth as a higher thread count if the peak is saturated with a small number of threads, but performance can alternatively become limited by latency such that utilization decreases with lower thread counts. Thus, approximation can generally be performed at the finest granularity that can be needed, or at multiple granularities, to avoid this ambiguity in the model.

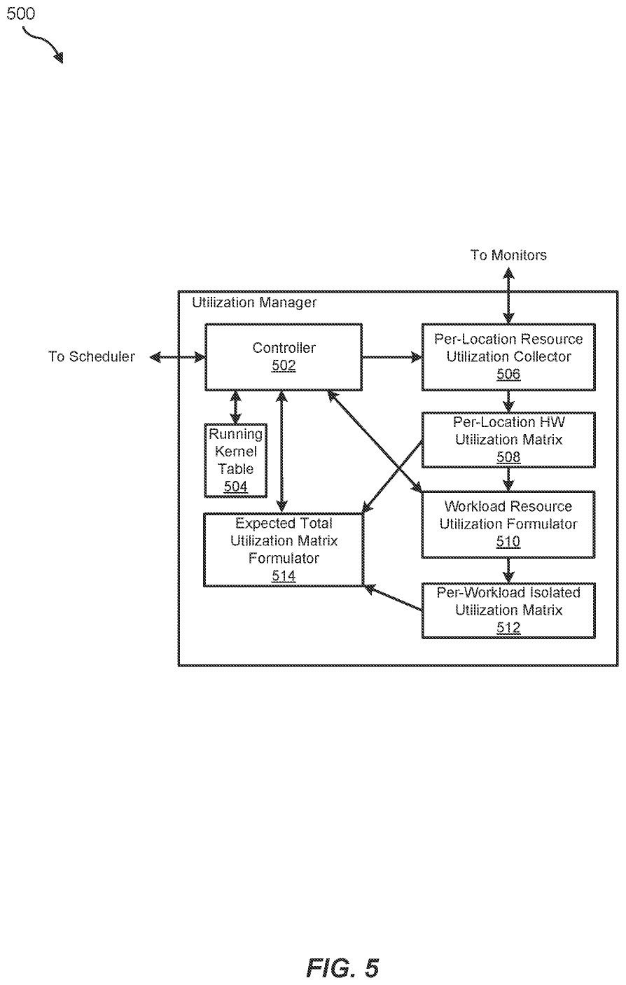

FIG. 5 illustrates operational components within an example utilization manager 500, such as utilization manager 420 of FIG. 4. Utilization manager 500 can be implemented in hardware, firmware, software, or a combination thereof. The main job of the utilization manager 500 is to provide information to the scheduler about the expected performance interference that would occur for different co-scheduling options. Example components that can be implemented to perform this functionality are a controller 502, a per-location hardware utilization matrix 508, a per-workload isolated utilization matrix 512, and a formulator 514 for formulating a total expected utilization matrix. Other components can include a running kernel table 504, a per-location resource utilization collector 506, and a workload resource utilization formulator 510. Controller 502 interfaces with the scheduler, monitors accuracy, and adjusts relevant parameters related to utilization gathering and analysis.

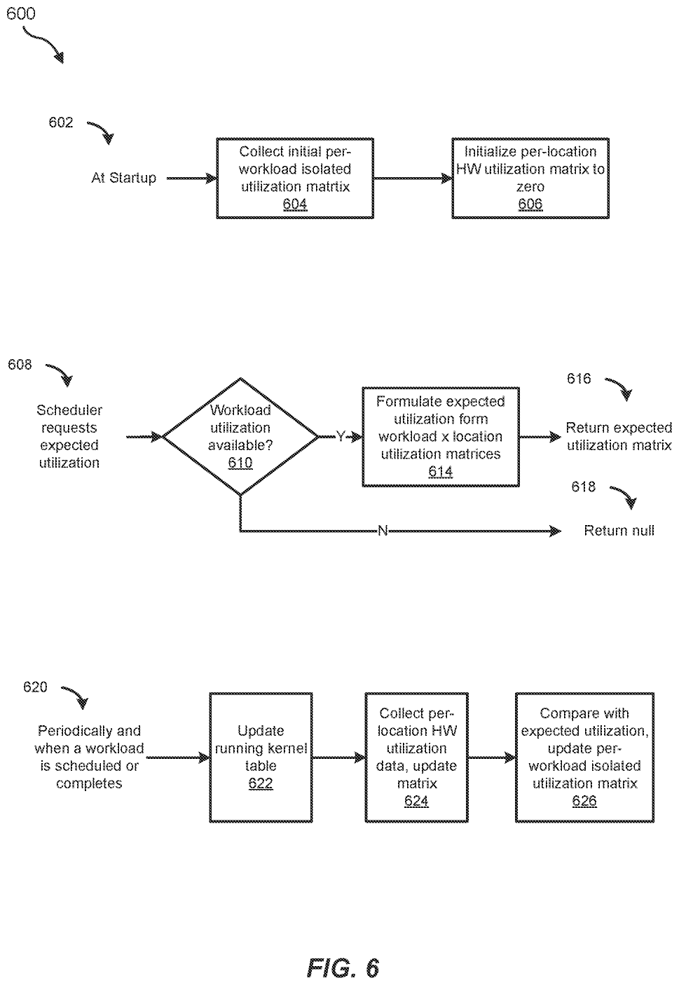

FIG. 6 illustrates example procedures 600 that can be performed by the scheduler at startup 602, when the scheduler requests, at 608, the total expected utilization for a set of locations and workloads, and at 620 either periodically and/or when a new workload being scheduled triggers an update. Example updates include an update to the running kernel table at 622, an update to the per-location hardware matrix at 624, and/or an update to the per-workload isolated utilization matrix at 626.

Controller 502 can interface with the scheduler in various ways. For example, controller 502 can interface with the scheduler when requesting the total expected utilization matrix for a scheduling decision, in which case the scheduler can provide, at 608, a set of locations and a set of workloads for a specified scheduling granularity. Controller 502 can respond by triggering total expected utilization matrix formulation at 614 for this set of locations and workloads and return the resulting matrix to the scheduler at 616. The total expected utilization matrix can represent the utilization of the limiting resource at a location when the current utilization is added to the expected utilization of a new workload for each <workload, location>pair supplied by the scheduler. Although the current per-location hardware and per-workload isolated expected utilization values represent proportions of peak, the result matrix can have values >100%, which can represent an extent to which the limiting resource would be overutilized, and thus how much performance for each workload would be degraded. A lower value can represent less interference, so the scheduler can prioritize these mappings when making a scheduling decision. Return of a null value at 618 represents lack of sufficient information for a confident estimate, as determined at 610. Similarly, a dedicated <high_interference> utilization value can be assigned for workloads and resources that are known to exhibit interference significantly higher than would be predicted by a roofline model, regardless of any workload, or lack thereof, with which they are coscheduled. This <high_interference> value can effectively be treated as a high utilization value (e.g., 100% of peak), and when such a workload is launched to a location, this value can override the current monitored utilization factor for that location until the workload completes.

The techniques described herein can also include assessment of monitoring accuracy. For example, every time a workload is scheduled, this scheduling is an opportunity for accuracy monitoring and adjustment. The formulation of the utilization matrix can involve estimating the expected change in utilization at each resource for a specified workload and location. If the expected increased resource utilization at this stage is >peak, the accuracy model can scale down all utilization equally so that the max utilization is at peak, and this scaling factor can represent the expected workload slowdown. By comparing this expected resource change and workload slowdown with the monitored change in resource utilization and performance after a <workload, location> pair is scheduled, controller 502 can estimate accuracy for this <workload, location> pair. Similarly, resource utilization data are periodically collected from the monitoring circuitry to update the current per-location hardware utilization matrix 508. If a running kernel table 504 is maintained (e.g., updated at kernel launch and completion), this table can be combined with the per-workload isolated utilization matrix 512 to estimate total expected utilization and compared against the actual utilization to provide another measure of accuracy.

The techniques described herein can also include managing relevant parameters. At startup 602, the controller 502 can initialize, at 606, the per-location hardware utilization matrix 508 to zero (e.g., assuming all resources start as idle), and it can initialize, at 604, the per-workload isolated utilization matrix 512. The per-workload isolated utilization matrix 512 can be initialized, at 604, based on stored values calculated from previous profiling, values derived from static analysis of workloads, or NULL values (e.g., which can indicate a lack of information). Based on the evaluated accuracy described above, the controller 502 can set utilization values to NULL (e.g., representing lack of information/accuracy), adjust the frequency of performance monitoring, trigger recalculation of workload utilization factors based on new monitoring data, and/or disable utilization monitoring and estimation entirely. The roofline model can be allowed to exhibit some imprecision, and these actions can be taken only for large divergences from expected behavior (e.g., utilization for a resource goes down when it should go up or vice versa).

The per-location hardware utilization matrix 508 can represent the current resource utilization at each location being monitored and/or considered for scheduling, and can be updated, at 624, based on monitoring frequency specified by the controller. The per-workload isolated utilization matrix 512 can represent the expected resource utilization for each workload that can be considered for scheduling, and it can be updated, at 626, as deemed necessary by the controller (i.e., based on measured accuracy). When the scheduler requests a total expected utilization matrix at 608, utilization values can be extracted from these matrices and used to formulate the requested matrix.

FIG. 7 illustrates an example process 700 of formulating the total expected utilization matrix 714. Based on target workloads and target locations specified by the scheduler at 702, a <#locations>x<#resources> matrix L of utilization values can be extracted, at 706, from the per-location hardware utilization matrix 704, and a <#workloads>x<#resources>matrix W of utilization values can be extracted, at 710, from the per-workload isolated utilization matrix 708. The extracted values of matrix L and/or matrix W can be scaled as described herein for the specified scheduling granularity, divided by the peak value for the specified resource at the specified location, and combined in an operation 712 resembling a matrix multiply (e.g., with <#resources> as the dimension being reduced) to produce a <#locations>x<#workloads>total expected utilization matrix 714 that can be returned to the scheduler at 718.

An example pseudocode for performing the operation 712 is given as:

Scheduling MatMul(L, W, parallelism, peak)

```
for l in locations:
  for w in workloads:
    curmax = 0
    # scale based on parallelism and peak
    par_factor = parallelism[l]
    peak_factor = 1
    for r in resources:
      peak_factor = min(peak_factor, peak[l,r]/par_factor*W[w,r])
    # determine max (limiting) resource
    for r in resources:
      pct_util = W[w,r]*par_factor*peak_factor
      curmax = max(curmax, L[l,r]+pct_util)
    total_util[l,w] = curmax
return total_util,
```

wherein the input W represents absolute utilization, while the input L holds utilization as a percentage of peak (e.g., it has already been scaled as it was extracted in FIG. 7). This MatMul includes both the scaling of W, as described herein, and its combination with the current hardware utilization to determine max resource interference for each pair. Unlike with L, W scaling is fused with this MatMul because both must loop over locations, workloads, and resources. The scaled percentage calculation of each <workload, resource> in W is added to the current percent utilization at each <location, resource> in L, and the maximum sum across all resources is taken for the output at the corresponding <workload, location>.

The matmul-like operation 712 used to combine per-location hardware and per-workload isolated utilization matrices can take multiple forms. FIG. 7 illustrates one example procedure. In this implementation, an output element is defined as the maximum over all resources of the sum of the workload and location utilizations specified (e.g., as a percentage of peak) by the output position. The intuition behind this method is that the more a workload interferes with other workloads running at a given location, the higher above 100% this sum will be. The resource with the highest sum above 100% represents the limiting resource, and this sum can be considered an estimated slowdown. Like standard GEMMs, this operation has complexity O(M×N×K), although this complexity can be reduced by allowing the scheduler to provide a mask specifying which <location, workload> pairs to consider, in which case other pairs do not need to be considered.

An alternative to the matmul-like operation 712 described in FIG. 7 can involve taking the variance rather than the max of the sum of utilization for each resource. In this implementation, high variance in resource utilization represents inefficiency, and utilization is improved if all resources are utilized equally rather than having resources with high and low utilization. Another alternative can involve using a machine learning mechanism (e.g., a neural network) which takes per-location hardware utilization and per-workload isolated utilization (or workload features statically derived from the compiler) as inputs and outputs an expected interference (or slowdown) metric. This mechanism can account for non-linear interference effects, and online training based on measured interference/slowdown can be used to improve the model.

While FIGS. 4-7 and related description thereof particularly describe the disclosed techniques with respect to data center resources, the disclosed techniques can be applied to CPUs, GPUs, other programmable accelerators, distributed heterogeneous systems, and any systems where different workloads share resources and can benefit from complementary scheduling. The techniques disclosed herein can be extended to improve accuracy or support other functions. For example, in some cases it can be beneficial to leverage the monitoring logic to raise an interrupt when certain conditions are met. For example, if there is exceptionally low utilization of resources, high utilization of resources, or a high variance in resource utilization, the monitoring circuitry can detect this utilization level and generate an interrupt to schedule more workloads, preempt currently executing workloads, or migrate workloads, respectively. Alternatively or additionally, the disclosed roofline-based throughput modeling can be used to provide predictions of kernel execution time and/or future system utilization states. This information can be very useful to the scheduler, and the utilization monitoring and analysis performed by the disclosed techniques enables such prediction with relatively minimal added state and control logic.

In an example implementation that provides predictions of kernel execution time and/or future system utilization states, the scheduler can query the expected completion time of running kernels. This query can be facilitated by adding a way to track running workloads in the utilization manager, as well as a mechanism for informing the utilization manager when a workload is launched or completes. This mechanism can be implemented as a per-location log that tracks which workloads are currently running at each location and relevant information associated with each running workload. Examples of such information include the timestamp of the latest update, the utilization of each resource at that timestamp, the approximate percent execution time remaining at that timestamp, and/or the expected completion time based on the last update.

Another piece of information that assist a completion time update can be the total amount of resources each workload will eventually consume over the course of its execution. Although, resource utilization is generally referred to herein as a throughput (i.e., <resource>/time), resource consumption can refer to a total amount of a resource. In the case of compute throughput, the total amount of a resource can be the total number of operations. In the case of memory bandwidth, the total amount of a resource can be the total number of bytes accessed from memory. The total amount of the resource can be calculated ahead of time either analytically (e.g., based on loop counts) or via profiling. An example profiling-based method can leverage the profiling disclosed herein to measure the resource utilization of a workgroup, then multiply the utilization by the execution time to obtain total resource consumption for the workgroup. This information can then be stored alongside the throughput-based utilization information in the per-workload isolated utilization matrix.

When a workload is launched to a location or completes at a location, the above fields for all workloads running at that location (e.g., including the newly launched workload) can be updated in various ways. For example, the timestamp of the last update can be set to the current timestamp. Additionally, the new utilization of each resource for a workload can be approximated by proportionally dividing the available resources (i.e., peak throughput) at the target location among running workloads based on the demand of each workload (e.g., from the per-workload isolated utilization matrix). Alternatively, this utilization information can be directly gathered from resource monitors that are able to differentiate utilization for different workloads.

The new approximate percent execution time remaining can be estimated by multiplying the pre-update utilization for each resource by the time since the last update, then subtracting this estimate from the total resource consumption remaining at the previous update. The proportion of this value divided by the total resource consumption can be the percent remaining for that resource, and the percent remaining for the workload can be defined as the maximum of the per-resource percentages. Alternatively, certain resources can be weighted based on past accuracy and ability of the resource monitor to differentiate between workloads. The new estimated completion time can be approximated by taking the new percent execution time remaining, multiplying it by the total resource consumption, and dividing the result by the current resource utilization.

In an example implementation, the completion time estimation can be made more precise by accounting for how future completions will affect resource utilization. This accounting can be accomplished by faking workload completion and repeating the above steps for each workload in order of expected completion time. In some implementations, these speculative steps only update the approximate completion time, none of the other parameters. The resulting execution time prediction can be leveraged at one or multiple scheduling granularities, and it can limit itself to a different set of workloads, resources, and locations than those used by the techniques disclosed herein.

As set forth above, the disclosed systems and methods provide techniques for quickly determining which workloads will not interfere with one another and scheduling them together. This capability is realized by measuring the proportion of shared resources utilized by each workload and providing this information to scheduling logic to coschedule workloads that are bottlenecked by different resources.

In addressing the difficult problem of complementary scheduling, the disclosed techniques exhibit multiple advantages. These advantages include use of a simple roofline-based interference estimation which requires only the individual utilization of each workload and the current utilization at each location. This estimation simplifies the profiling overhead (e.g., no need to collect and store N\hat{ }2 interference metrics for N workloads, can easily collect and update utilization information, etc.), and it allows for relatively simple calculation of interference. The hierarchical nature allows for multi-level scheduling while avoiding duplication of resources (e.g., common resources, logic, infrastructure, etc.) across scheduling levels. It also can easily identify and adapt to workloads and situations where a high-level estimation is not accurate.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example system 100 in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example system 100 in FIG. 1 can be implemented within a virtual environment. For example, the modules and/or data described herein can reside and/or execute within a virtual machine. As used herein, the term “virtual machine” generally refers to any operating system environment that is abstracted from computing hardware by a virtual machine manager (e.g., a hypervisor).

In some examples, all or a portion of example system 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computing device, comprising:
collection circuitry configured to collect current resource utilization per shared resource location; and
formulation circuitry configured, using expected resource utilization information of a new workload and the current resource utilization, to provide a scheduler with one or more expected utilization metrics.

2. The computing device of claim 1, further comprising:
monitoring circuitry configured to measure resource utilization of currently running workloads at different shared resource locations and provide the measured resource utilization to the collection circuitry.

3. The computing device of claim 2, further comprising:
a scheduler configured to schedule workloads that utilize shared resources at one or more of the different shared resource locations based at least in part on the one or more expected utilization metrics.

4. The computing device of claim 3, wherein the different shared resource locations correspond to multiple hierarchical locations at different hierarchical sharing levels, the monitoring circuitry is configured to measure the current resource utilization of the currently running workloads at different hierarchical granularities, and the scheduler is configured to perform multi-level scheduling while avoiding duplication of resources across different scheduling levels.

5. The computing device of claim 1, wherein the one or more expected utilization metrics correspond to a total expected utilization matrix that represents utilization of a limiting resource at a location when a current utilization is added to the expected resource utilization information of the new workload for each workload and location pair supplied by the scheduler.

6. The computing device of claim 5, wherein the formulation circuitry is configured to maintain the current resource utilization per location in a per-location hardware utilization matrix that represents the current resource utilization at each location that is at least one of being monitored or indicated by the scheduler as under consideration for scheduling.

7. The computing device of claim 6, wherein the formulation circuitry is configured to maintain the expected resource utilization information of the new workload in a per-workload isolated utilization matrix that represents the expected resource utilization for each workload indicated by the scheduler as under consideration for scheduling.

8. The computing device of claim 7, wherein the formulation circuitry is configured to formulate the total expected utilization matrix at least in part by:
extracting a locations dimension by resources dimension matrix of utilization of values from the per-location hardware utilization matrix;
extracting a workloads dimension by resources dimension matrix of utilization values from the per-workload isolated utilization matrix; and
combining the locations dimension by resources dimension matrix of utilization of values and the workloads dimension by resources dimension matrix of utilization values by reducing the resources dimension in a manner that produces a locations dimension by workloads dimension total expected utilization matrix.

9. The computing device of claim 8, wherein the formulation circuitry is further configured to formulate the total expected utilization matrix at least in part by:
scaling, for a specified scheduling granularity, utilization values extracted from the per-workload isolated utilization matrix; and
dividing the scaled utilization values by a peak value for a specified resource at a specified location.

10. The computing device of claim 1, wherein the formulation circuitry is further configured to:
evaluate predicted interference based on post-monitoring scheduling; and
respond to the evaluation for non-amenable at least one of workloads or systems by at least one of:
disabling provision of the one or more expected utilization metrics to the scheduler; or
providing the scheduler with one or more expected utilization metrics corresponding to null values.

11. The computing device of claim 1, wherein the formulation circuitry is further configured to provide a predicted execution time to the scheduler based on resource usage and availability.

12. A system, comprising:
at least one physical processor; and
physical memory comprising computer-executable instructions that, when executed by the physical processor, cause the physical processor to:
collect current resource utilization per shared resource location; and
provide, using expected resource utilization information of a new workload and the current resource utilization, a scheduler with one or more expected utilization metrics.

13. The system of claim 12, wherein the instructions further cause the physical processor to:
measure resource utilization of currently running workloads at different shared resource locations.

14. The system of claim 13, wherein the instructions further cause the physical processor to:
schedule workloads that utilize shared resources at one or more of the different shared resource locations based at least in part on the one or more expected utilization metrics.

15. The system of claim 14, wherein the different shared resource locations correspond to multiple hierarchical locations at different hierarchical sharing levels, and the instructions further cause the physical processor to:
measure the current resource utilization of the currently running workloads at different hierarchical granularities; and
perform multi-level scheduling while avoiding duplication of resources across different scheduling levels.

16. The system of claim 12, wherein the one or more expected utilization metrics correspond to a total expected utilization matrix that represents utilization of a limiting resource at a location when a current utilization is added to the expected resource utilization information of the new workload for each workload and location pair.

17. The system of claim 16, wherein the instructions further cause the physical processor to maintain the current resource utilization per location in a per-location hardware utilization matrix that represents the current resource utilization at each location that is at least one of being monitored or under consideration for scheduling.

18. The system of claim 17, wherein the instructions further cause the physical processor to maintain the expected resource utilization information of the new workload in a per-workload isolated utilization matrix that represents the expected resource utilization for each workload under consideration for scheduling.

19. A computer-implemented method, comprising:
collecting, by at least one processor, current resource utilization per shared resource location; and
providing, by the at least one processor and using expected resource utilization information of a new workload and the current resource utilization, a scheduler with one or more expected utilization metrics.

20. The method of claim 19, further comprising:
measuring, by the at least one processor, resource utilization of currently running workloads at different shared resource locations; and
scheduling, by the at least one processor, workloads that utilize shared resources at one or more of the different shared resource locations based at least in part on the one or more expected utilization metrics.
